(19) United States
(12) Patent Application Publication
(10) Pub. No.: US 2020/0335003 A1
(43) Pub. Date: Oct. 22, 2020

(54) STEM ENHANCED QUESTION BUILDER

(71) Applicant: Intellistem Writer Corporation, Oklahoma City, OK (US)

(72) Inventors: Ruth Ann Eckenstein, Oklahoma City, OK (US); Edward Eckenstein, Oklahoma City, OK (US)

(21) Appl. No.: 16/851,683

(22) Filed: Apr. 17, 2020

Related U.S. Application Data
(60) Provisional application No. 62/835,188, filed on Apr. 17, 2019.

(51) Int. Cl. G09B 7/077

(52) U.S. Cl. CPC G09B 7/077

(57) ABSTRACT

Disclosed are systems and methods for building exams including accessing an exam question stem from a database, the exam question stem having a modifiable portion and an unmodifiable portion. Displaying the exam question stem on a display device an accepting input from a user, the input changing the modifiable portion of the exam question stem. Saving the modified exam question stem as a new exam question as part of a new exam. Because the unmodifiable portion contains the necessary language that establishes the exam question stem as genuinely compatible with the standards assigned to the stem, the new exam question is ensured to be compliant with a desired standard.

### INCORPORATION BY REFERENCE

The present patent application claims priority to a provisional patent application identified by U.S. Provisional Application No. 62/835,188 filed Apr. 17, 2019, the disclosure of which is incorporated herein by reference in its entirety.

### TECHNICAL FIELD OF DISCLOSURE

This disclosure relates generally to the field of educational software and more specifically to the development of exam questions over a network.

### BACKGROUND

Testing in educational settings is aimed at assessing the student's mastery of the subject matter. However, the validity of the assessment is only as good as the questions asked on the exam.

To ensure exams contain quality questions, institutions or programs develop educational standards and/or adopt standards developed by a third party such as an accreditation body. An institution may establish a test blueprint to help ensure instructors develop exams aligned to standards. These typically mandate the topic areas and the cognitive rigor for exams. For example, pre-licensure nursing programs may choose to align their exams to a standard such as the National League of Nursing's (NLN) End of Program Competencies.

While teachers or instructors may have mastered the topics they teach, they aren't usually trained in the skills of writing exam questions (also known as “item writing”). Even when they do receive training, it's a skill that can take years to master.

More often, it's left up to the instructor to learn how to write question. Well written items take into account factors such as cognitive level. Unskilled question writers tend to develop exams containing questions that mainly test students' knowledge which they can pass by only memorizing facts and details. When test questions are written to assess a student's ability to apply higher-order thinking skills (such as applying, analyzing, or evaluating what they learned), students must demonstrate mastery not just memorization skills. Higher-order thinking skills can be targeted by aligning questions to human cognition models such as “Bloom's Taxonomy”.

Teachers or instructors commonly develop exam questions by writing the part of the question called the stem. The stem is part of questions that asks the student to solve a problem or answer a question. Then the teacher develops the correct answer and incorrect answers (aka “distractors”) without the aid of any prepared stems. If done correctly, this question-writing development takes between one and three hours or more per question to write.

Another factor is that the questions must assess the subject matter adequately as well as the content, both in depth and breadth. In some academic fields, standards or certification bodies mandate the content to be assessed and publish the standards.

Once written, a question isn't automatically aligned to any standards. Aligning the question requires a separate process. For programs seeking national accreditation, accrediting entities require schools to cross-reference each question to one of the entity's specific standards to prove what is being taught is actually assessed in student exams. This alignment analysis takes another hour or so per question. Therefore, to develop a question without any aids that aligns with accreditation standards may take up to 5 hours. Thus, for a 15 question exam, the question writing process could take 3 or 4 full staff days of time.

Another issue arises regarding the ability of less-experienced instructors to apply accreditation standards consistently. Exam questions written by new instructors tend to vary widely in their consistency for addressing the right standard. This inconsistency occurs both within the same exam as well as across a series of exams within the same course.

Development of sound question items takes a lot of time and instructors often lack the time and training to do it well. Publishing companies understand this and sometimes provide instructors test question “banks” with their textbooks to help out. However, these question banks inevitably and quickly appear for sale online where students can purchase exams and answers, thereby jeopardizing the effectiveness of exams.

If students are not given tests including questions with enough cognitive rigor, or the students can purchase the answers online, the assessment will fail to measure the students' abilities and they're not likely to be prepared to practice the skills in which they were trained. It is well known that inadequately prepared students are more likely to fail professional licensure exams. And this will be after incurring substantial student loan debt without being able to subsequently practice in a field that pays well. In some occupations, such as engineering, healthcare, or automotive repair, inadequate preparation can lead to mistakes that can cause serious injury or even death.

There are online question writing tools included in many learning management systems and educational analytics packages. However, these are simple electronic forms that the instructor fills in. It's still up to the instructor or teacher to know or be guided on how to write good questions and align the questions to an appropriate applicable accreditation standard.

There's a commercial product with starter question stems for nursing education. But, these types of stems are aligned to only one or two standards. Each stem is printed, and has a modifiable part and a fixed part. The fixed part is not intended to be changed as it is that part that is aligned to the standard. To develop questions for an exam, the instructor must read the non-modifiable part and type it in to a word processor or other electronic system and add then add the instructor's content to complete the question. During that process, if the instructor modifies the fixed part (the stem), alignment to the standard becomes invalid and destroys the value of using pre-developed stems. These problems are not limited to the commercial product in this example but extend to any other use of pre-developed stems used in an uncontrolled environment.

Accordingly, a need has emerged for an improved on-line, item question-writing solution that addresses some or all of the previously discussed problems.

### SUMMARY OF THE DISCLOSURE

The present disclosure (the “system”) generally provides a way to write assessments including test, exam, and quiz questions over a network using a database of pre-developed, pre-aligned, enforceable question starter stems. The use of pre-aligned stems helps enforce the alignment of an exam question to meet an entity's standards blueprint, standards requirements, or cognitive level requirements.

The system enables users to find and select a stem aligned to a desired standard from stems filtered and pulled from database. Each stem is the foundation for an infinite number of new and unique questions. Once the user is guided by the disclosure and changes the modifiable part of a stem to complete the question, the newly created question is automatically pre-aligned to the targeted standard because of the fixed portion of the stem. This is an improvement on existing “free form” or “blank box” question writing tools in use where no question stem or standards-based question stem framework is provided.

In one embodiment, new questions are developed using pre-developed, standards-aligned stems and added to an exam. As questions are developed and saved, the application automatically tracks standards alignment metrics. These are displayed to the user to help the user track progress toward the desired exam blueprint and/or exam alignment goals. Alignment metrics summaries are continuously updated during exam development. Summaries of completed exams are stored and available for future review or re-use. A team commenting and collaboration feature facilitates collaboration between instructors to jointly develop examinations, or critique any questions, answers or distractors during exam development. The collaboration feature also enables more experienced instructors to teach less experienced instructors in the concepts of item-writing and exam development.

Completed exams may be exported to various file formats that allow users to import their questions into assessment tools which include, but are not limited to, learning management, test administration, and test analysis systems. On export, exams and their associated comments are automatically archived in a read-only state to ensure that exam integrity is preserved. This preservation feature helps institutions document standards compliance for accreditation auditing purposes. Institutional officials, program managers and auditors from accreditation bodies can review an educational institution's archived exams, associated instructor comments and standards-alignment tracking to check progress, compliance and for formal auditing purposes.

### Advantages

The use of pre-built, pre-aligned starter stems simplifies writing and aligning exam questions to accreditation standards. This allows less experienced instructors to write questions on a level comparable to much more experienced instructors and teaches less experienced instructors how to write better questions.

The metric tracking and automatic archive features help document accreditation standards compliance. In one embodiment, exams cannot be exported without first being archived and the archiving feature cannot be disabled. This gives reviewers and accreditors from professional standards bodies confidence that the exam data is accurate and has not been altered to present a more favorable outcome than the original data would reflect when the test was actually administered.

Consistency is improved since question stems are pre-aligned, thereby overcoming instructors' inexperience and the differing opinions of which standard applies to a question. Because of this consistency, the system can be used to track progress and improvement over time.

In the system's Question Builder interface, each standards-aligned stem will include a fixed portion (also referred to as an unmodifiable portion) and an editable portion (also referred to as a modifiable portion). The wording of the fixed portion determines the stem's standard alignment. In some embodiments, the system only allows the user to change the editable portion of the stem. This is an improvement over manual methods that use stems in an uncontrolled environment where the instructor could deliberately or inadvertently change the fixed portion and invalidate the stem's alignment to a standard. This helps to ensure more consistent exams that meet the necessary standards and outcomes that are reliable indications of the test takers understanding of the material.

Specific standards criteria can be targeted while building a question to match an exam blueprint or standards goal established by the academic institution. A progress indicator in the question builder interface shows question counts for the currently targeted standard. A detailed summary of all standards covered by the exam's questions is shown in an exam summary screen.

The archival of exams as read-only data supports exam integrity by preventing modification after the exam has been exported for test administration. This “point in time” exam snapshot allows managers and accreditors access to review the history of any course across time by analyzing all the exams developed for the course. Collaboration comments are also stored with the exam and available for performance review.

The system may prompt instructors about required information as the instructors build exams, thereby preventing errors and gaps.

This system reduces the staff time required to write standards-aligned exam questions from “scratch” by up to 75 percent, for instance.

Even more time can be saved by recycling part of a question, such as a scenario, from an existing question drawn from an institution's existing question pool or a publisher's test bank and using the recycled part of the question to generate a new, high-quality question. This is done by using the recycled part as content for the modifiable part of the system's pre-developed, pre-aligned stem.

Once questions are written using this system, they are easy to revise without changing an exam's overall alignment. For example, an exam blueprint may dictate that the exam contains a question mix consisting of 10% standard #1, 20% standard #2, 40% standard #3 and 30% standard #4. An instructor doesn't need to find new stems matching the required standards, they just make and open a copy of an existing exam and change the modifiable part of the stem to develop a new question aligned to the standard originally selected.

### BRIEF DESCRIPTION OF THE DRAWINGS

To assist those of ordinary skill in the relevant art in making and using the subject matter hereof, reference is made to the appended drawings, which are not intended to be drawn to scale, and in which like reference numerals are intended to refer to similar elements for consistency. For purposes of clarity, not every component may be labeled in every drawing.

FIG. 1 is a diagrammatic view of hardware forming an exemplary embodiment of a system for building stem-based questions constructed in accordance with the present disclosure.

FIG. 2 is a diagrammatic view of an exemplary user device for use in the system for building stem-based questions illustrated in FIG. 1.

FIG. 3 is a diagrammatic view of an exemplary embodiment of a host system for use in the system for building stem-based questions illustrated in FIG. 1.

FIG. 4 is a block diagram illustrating a general model of stem-based question constructed in accordance with the present disclosure.

FIG. 5 is a flow diagram illustrating exemplary steps for creating a question stem.

FIG. 6 illustrates an exemplary new exam screen showing how a new exam is initiated, constructed in accordance with the present disclosure.

FIG. 7A illustrates an exemplary screen for management of an instructor's exam(s), constructed in accordance with the present disclosure.

FIG. 7B illustrates an exemplary parameters screen for the configuration of an exam's overall parameter(s), constructed in accordance with the present disclosure.

FIG. 7C illustrates an exemplary confirmation screen for the archiving of a completed exam, constructed in accordance with the present disclosure.

FIG. 7D illustrates an exemplary transfer screen for transferring ownership of an exam between instructors, constructed in accordance with the present disclosure.

FIG. 7E illustrates an exemplary instructor collaboration screen for adding collaborators to an exam, constructed in accordance with the present disclosure.

FIG. 7F illustrates an exemplary export screen for exporting an archived exam for test administration, constructed in accordance with the present disclosure.

FIG. 8A illustrates an exemplary outcome and objective screen for the inclusion of course Learning Outcomes and Unit Objectives to guide question development, constructed in accordance with the present disclosure.

FIG. 8B illustrates an exemplary question ideas screen for a topical generator to provide instructors with question ideas, constructed in accordance with the present disclosure.

FIG. 8C illustrates an exemplary question stem screen used for the selection and configuration of a standard-aligned stem in a question, constructed in accordance with the present disclosure.

FIG. 8D illustrates an exemplary alternate stems screen for the retrieval of alternative standard-aligned stems, constructed in accordance with the present disclosure.

FIG. 8E illustrates an exemplary answers screen for the configuration of correct and incorrect question answers, constructed in accordance with the present disclosure.

FIG. 9A illustrates an exemplary exam summary screen, constructed in accordance with the present disclosure.

FIG. 9B illustrates an exemplary edit existing question screen for the purpose of editing existing exam questions, constructed in accordance with the present disclosure.

FIG. 9C illustrates an exemplary comments screen for the purpose of attaching comments to an exam, constructed in accordance with the present disclosure.

FIG. 9D illustrates an exemplary standards screen that displays a test blueprint showing all standards selected for covered in a specific exam, constructed in accordance with the present disclosure.

FIG. 9E illustrates an exemplary screen that displays a list of question stems that align to a selected standard, constructed in accordance with the present disclosure.

FIG. 10A illustrates an exemplary screen displaying an examination question builder constructed in accordance with the present disclosure.

FIG. 10B illustrates an exemplary screen displaying the examination question builder of FIG. 10A having a visual indicator providing a warning that editing a portion of a question may result in the question no longer being compliant with a selected standard in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted.

The systems and methods as described in the present disclosure are capable of other embodiments or of being practiced or carried out in various ways. Also, it is to be understood that the phraseology and terminology employed herein is for purposes of description, and should not be regarded as limiting in any way.

The following detailed description refers to the accompanying drawings. The same reference numbers in different drawings may identify the same or similar elements.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements, but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, any reference to “one embodiment,” “an embodiment,” “some embodiments,” “one example,” “for example,” or “an example” means that a particular element, feature, structure or characteristic described in connection with the embodiment is included in at least one embodiment. The appearance of the phrase “in some embodiments” or “one example” in various places in the specification is not necessarily all referring to the same embodiment, for example.

The present disclosure provides a stem enhanced question and exam builder and supporting features such as exam management, administration and reporting that are implemented with a computer to provide a computer automated method and system to technologically solve the problems discussed above.

In accordance with the present disclosure, certain components of the system and method include circuitry. Circuitry, as used herein, could be analog and/or digital components, or one or more suitably programmed microprocessors and associated hardware and software, or hardwired logic. Also, certain portions of the implementations may be described as “components” that perform one or more functions. The term “component,” may include hardware, such as a processor, an application specific integrated circuit (ASIC), or a field programmable gate array (FPGA), or a combination of hardware and software. Software includes one or more computer executable instructions that when executed by one or more component cause the component to perform a specified function. It should be understood that the algorithms described herein are stored on one or more non-transitory memory. Exemplary non-transitory memory includes random access memory, read only memory, flash memory or the like. Such non-transitory memory can be electrically based or optically based.

The term “screen” as used herein refers to a panel or area on an electronic device such as a television, computer monitor, smartphone, virtual reality headset or the like on which images and data are displayed. The “screen” can be implemented in a variety of manners. For example, the images and data may be displayed using any suitable technology, such as html. When html is used, the “screen” may be referred to in the art as a “page”, “interface”, “view” or “web page”. The screen may include one or more areas for data input or data selection. In some embodiments, the screen may permit interaction with one or more databases. In this example, the screen may be a form view in which one or more fields of a single record are displayed on the screen and arranged in an organized format that may be understandable by the user. In some embodiments, the screen can be used to add, edit, and view data. For example, the user can use an input device to add and edit the data.

Circuitry, as used herein, may be analog and/or digital components, or one or more suitably programmed processors (e.g., microprocessors) and associated hardware and software, or hardwired logic. Also, “components” may perform one or more functions. The term “component” may include hardware, such as a processor (e.g., microprocessor), a combination of hardware and software, and/or the like. Software may include one or more computer executable instructions that when executed by one or more components cause the component to perform a specified function. It should be understood that the algorithms described herein may be stored on one or more non-transitory memory. Exemplary non-transitory memory may include random access memory, read only memory, flash memory, and/or the like. Such non-transitory memory may be electrically based, optically based, and/or the like.

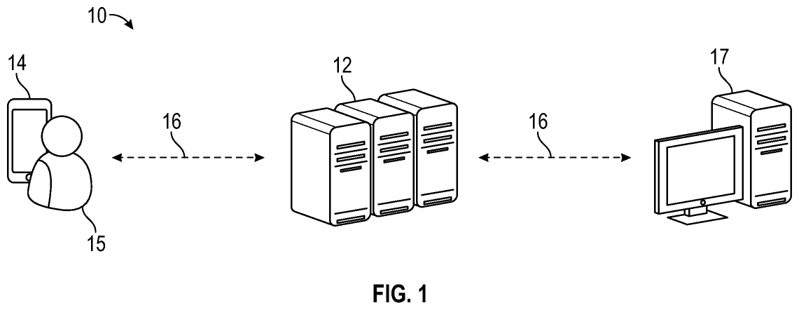

Referring now to the Figures, and in particular to FIG. 1, shown therein is a diagrammatic view of hardware forming an exemplary embodiment of a system 10 for building stem-based questions constructed in accordance with the present disclosure.

The system 10 is provided with at least one host system 12 (hereinafter “host system 12”), a plurality of user devices 14 (hereinafter “user device 14”), and a network 16. In some embodiments, the system 10 may include at least one external system 17 (hereinafter “external system 17”) for use by an administrator to add, delete, or modify user information, add, delete, or modify stem-based questions, provide management reporting, or manage banking information. The system 10 may be a system or systems that are able to embody and/or execute the logic of the processes described herein. Logic embodied in the form of software instructions and/or firmware may be executed on any appropriate hardware. For example, logic embodied in the form of software instructions and/or firmware may be executed on a dedicated system or systems, on a personal computer system, on a distributed processing computer system, and/or the like. In some embodiments, logic may be implemented in a stand-alone environment operating on a single computer system and/or logic may be implemented in a networked environment such as a distributed system using multiple computers and/or processors as depicted in FIG. 1, for example.

The host system 12 of the system 10 may include a single processor or multiple processors working together or independently to perform a task. In some embodiments, the host system 12 may be partially or completely network-based or cloud based. The host system 12 may or may not be located in single physical location. Additionally, multiple host systems 12 may or may not necessarily be located in a single physical location.

In some embodiments, the system 10 may be distributed, and include at least one host system 12 communicating with one or more user device 14 via the network 16. As used herein, the terms “network-based,” “cloud-based,” and any variations thereof, are intended to include the provision of configurable computational resources on demand via interfacing with a computer and/or computer network, with software and/or data at least partially located on a computer and/or computer network.

In some embodiments, the network 16 may be the Internet and/or other network. For example, if the network 16 is the Internet, a primary user interface of the system 10 may be delivered through a series of web pages or private internal web pages of a company or corporation, which may be written in hypertext markup language. It should be noted that the primary user interface of the system 10 may be another type of interface including, but not limited to, a Windows-based application, a tablet-based application, a mobile web interface, and/or the like.

The network 16 may be almost any type of network. For example, in some embodiments, the network 16 may be a version of an Internet network (e.g., exist in a TCP/IP-based network). It is conceivable that in the near future, embodiments within the present disclosure may use more advanced networking technologies.

In some embodiments, the external system 17 may optionally communicate with the host system 12. For example, in one embodiment of the system 10, the external system 17 may supply data transmissions via the network 16 to the host system 12 regarding real-time or substantially real-time events (e.g., user updates, stem-based questions updates, and/or test updates). Data transmission may be through any type of communication including, but not limited to, speech, visuals, signals, textual, and/or the like. Events may include, for example, data transmissions regarding user messages or updates from a test preparer, for example, initiated via the external system 17. It should be noted that the external system 17 may be the same type and construction as the user device 14.

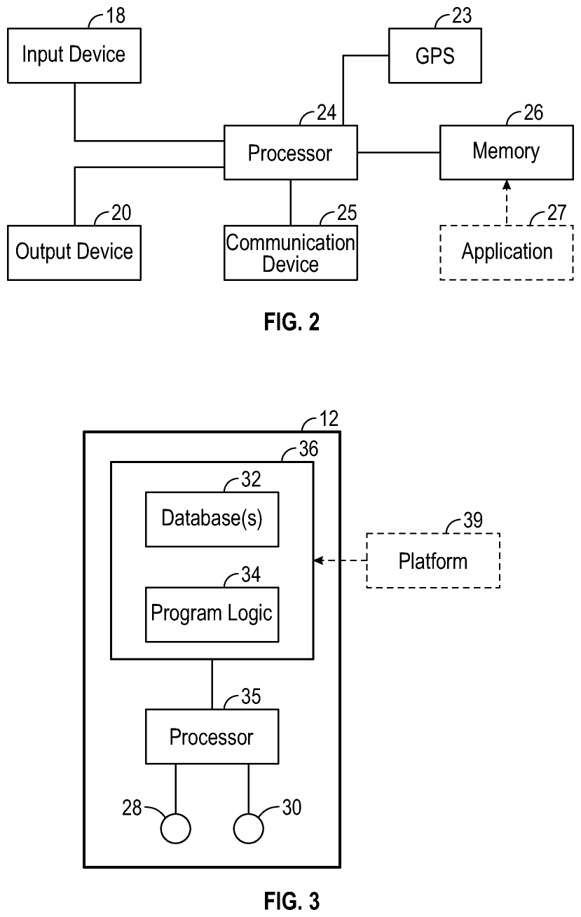

As shown in FIG. 2, the one or more user devices 14 of the system 10 may include, but are not limited to implementation as a cellular telephone, a smart phone, a tablet, a laptop computer, a desktop computer, a network-capable handheld device, a server, a wearable network-capable device, and/or the like.

In some embodiments, the user device 14 may include one or more input devices 18 (hereinafter “input device 18”), one or more output devices 20 (hereinafter “output device 20”), a device locator 23, one or more processors 24 (hereinafter “processor 24”), one or more communication devices 25 (hereinafter “communication device 25”) capable of interfacing with the network 16, one or more non-transitory memory 26 (hereinafter “memory 26”) storing processor executable code and/or software application(s), for example including, a web browser capable of accessing a website and/or communicating information and/or data over a wireless or wired network (e.g., network 16), and/or the like. The memory 26 may also store an application 27. In some embodiments, the application 27 is programmed to cause the processor 24 to provide a user input screen (not shown) to the output device 20, and to receive information from a user 15 via the input device 18. Such information can be stored either temporarily and/or permanently in the memory 26 and/or transmitted to the host system 12 via the network 16 using the communication device 25 and may include, for instance, a personal identification number (PIN), a password, a digital access code, or the like.

Embodiments of the system 10 may also be modified to use any user device 14 or future developed devices capable of communicating with the host system 12 via the network 16.

The device locator 23 may be capable of determining the position of the user device 14. For example, implementations of the device locator 23 may include, but are not limited to, a Global Positioning System (GPS) chip, software based device triangulation methods, network-based location methods such as cell tower triangulation or trilateration, the use of known-location wireless local area network (WLAN) access points using the practice known as “wardriving”, a hybrid positioning system combining two or more of the technologies listed above, or any future developed system or method of locating a device such as the user device 14.

The input device 18 may be capable of receiving information input from the user and/or processor 24, and transmitting such information to other components of the user device 14 and/or the network 16. The input device 18 may include, but are not limited to, implementation as a keyboard, touchscreen, mouse, trackball, microphone, fingerprint reader, infrared port, slide-out keyboard, flip-out keyboard, cell phone, PDA, remote control, fax machine, wearable communication device, network interface, combinations thereof, and/or the like, for example.

The output device 20 may be capable of outputting information in a form perceivable by the user and/or processor 24. For example, implementations of the output device 20 may include, but are not limited to, a computer monitor, a screen, a touchscreen, a speaker, a website, a television set, a smart phone, a PDA, a cell phone, a laptop computer, combinations thereof, and the like, for example. It is to be understood that in some exemplary embodiments, the input device 18 and the output device 20 may be implemented as a single device, such as, for example, a touchscreen of a computer, a tablet, or a smartphone. It is to be further understood that as used herein the term user 15 is not limited to a human being, and may comprise, a computer, a server, a website, a processor, a network interface, a human, a user terminal, a virtual computer, combinations thereof, and/or the like, for example.

The host system 12 may be capable of interfacing and/or communicating with the user device 14 and the external system 17 via the network 16. For example, the host system 12 may be configured to interface by exchanging signals (e.g., analog, digital, optical, and/or the like) via one or more ports (e.g., physical ports or virtual ports) using a network protocol, for example. Additionally, each host system 12 may be configured to interface and/or communicate with other host systems 12 directly and/or via the network 16, such as by exchanging signals (e.g., analog, digital, optical, and/or the like) via one or more ports.

The network 16 may permit bi-directional communication of information and/or data between the host system 12, the user device 14, and/or the external system 17. The network 16 may interface with the host system 12, the user device 14, and/or the external system 17 in a variety of ways. For example, in some embodiments, the network 16 may interface by optical and/or electronic interfaces, and/or may use a plurality of network topographies and/or protocols including, but not limited to, Ethernet, TCP/IP, circuit switched path, combinations thereof, and/or the like. For example, in some embodiments, the network 16 may be implemented as the World Wide Web (or Internet), a local area network (LAN), a wide area network (WAN), a metropolitan network, a 4G network, a 5G network, a satellite network, a radio network, an optical network, a cable network, a public switch telephone network, an Ethernet network, combinations thereof, and the like, for example. Additionally, the network 16 may use a variety of network protocols to permit bi-directional interface and/or communication of data and/or information between the host system 12, the user device 14 and/or the external system 17.

Referring now to FIG. 3, shown therein is a diagrammatic view of an exemplary embodiment of the host system 12. In the illustrated embodiment, the host system 12 is provided with one or more databases 32 (hereinafter “database 32”), program logic 34, and one or more processors 35 (hereinafter “processor 35”). The program logic 34 and the database 32 are stored on non-transitory computer readable storage memory 36 (hereinafter “memory 36”) accessible by the processor 35 of the host system 12. It should be noted that as used herein, program logic 34 is another term for instructions which can be executed by the processor 24 or the processor 35. The database 32 can be a relational database or a non-relational database. Examples of such databases comprise, DB2®, Microsoft® Access, Microsoft® SQL Server, Oracle®, mySQL, PostgreSQL, MongoDB, Apache Cassandra, and the like. It should be understood that these examples have been provided for the purposes of illustration only and should not be construed as limiting the presently disclosed inventive concepts. The database 32 can be centralized or distributed across multiple systems.

In some embodiments, the host system 12 may comprise one or more processors 35 working together, or independently to, execute processor executable code stored on the memory 36. Additionally, each host system 12 may include at least one input device 28 (hereinafter “input device 28”) and at least one output device 30 (hereinafter “output device 30”). Each element of the host system 12 may be partially or completely network-based or cloud-based, and may or may not be located in a single physical location.

The processor 35 may be implemented as a single processor or multiple processors working together, or independently, to execute the program logic 34 as described herein. It is to be understood, that in certain embodiments using more than one processor 35, the processors 35 may be located remotely from one another, located in the same location, or comprising a unitary multi-core processor. The processors 35 may be capable of reading and/or executing processor executable code and/or capable of creating, manipulating, retrieving, altering, and/or storing data structures into the memory 36.

Exemplary embodiments of the processor 35 may be include, but are not limited to, a digital signal processor (DSP), a central processing unit (CPU), a field programmable gate array (FPGA), a microprocessor, a multi-core processor, combinations, thereof, and/or the like, for example. The processor 35 may be capable of communicating with the memory 36 via a path (e.g., data bus). The processor 35 may be capable of communicating with the input device 28 and/or the output device 30.

The processor 35 may be further capable of interfacing and/or communicating with the user device 14 and/or the external system 17 via the network 16. For example, the processor 35 may be capable of communicating via the network 16 by exchanging signals (e.g., analog, digital, optical, and/or the like) via one or more ports (e.g., physical or virtual ports) using a network protocol to provide updated information to the application 27 executed on the user device 14.

The memory 36 may be capable of storing processor executable code. Additionally, the memory 36 may be implemented as a conventional non-transitory memory, such as for example, random access memory (RAM), CD-ROM, a hard drive, a solid state drive, a flash drive, a memory card, a DVD-ROM, a disk, an optical drive, combinations thereof, and/or the like, for example.

In some embodiments, the memory 36 may be located in the same physical location as the host system 12, and/or one or more memory 36 may be located remotely from the host system 12. For example, the memory 36 may be located remotely from the host system 12 and communicate with the processor 35 via the network 16. Additionally, when more than one memory 36 is used, a first memory 36 may be located in the same physical location as the processor 35, and additional memory 36 may be located in a location physically remote from the processor 35. Additionally, the memory 36 may be implemented as a “cloud” non-transitory computer readable storage memory (i.e., one or more memory 36 may be partially or completely based on or accessed using the network 16).

The input device 28 of the host system 12 may transmit data to the processor 35 and may be similar to the input device 18 of the user device 14. The input device 28 may be located in the same physical location as the processor 35, or located remotely and/or partially or completely network-based. The output device 30 of the host system 12 may transmit information from the processor 35 to a user, and may be similar to the output device 20 of the user device 14. The output device 30 may be located with the processor 24, or located remotely and/or partially or completely network-based.

The memory 36 may store processor executable code and/or information comprising the database 32 and program logic 34. In some embodiments, the processor executable code may be stored as a data structure, such as the database 32 and/or data table, for example, or in non-data structure format such as in a non-compiled text file.

The system 10 includes a stem-enhanced question and exam builder and supporting features such as exam management, administration and reporting. Multiple roles are provided for each institution to administer their users, create/manage courses, build and manage exams, and to customize system options to meet their needs. Supported roles include a School Coordinator, Curriculum Coordinator, Instructor, and Reviewer. School Coordinators are the administrator with full rights over the institution's data and policy configurations. Curriculum Coordinators can manage exam metadata such as academic periods and course titles but cannot access actual exams or questions. Instructors have rights to the exams they build or are invited to collaborate on. Reviewers are a special role set aside for internal or external accreditation personnel, auditors, or researchers.

### Core Question Construction Process Overview

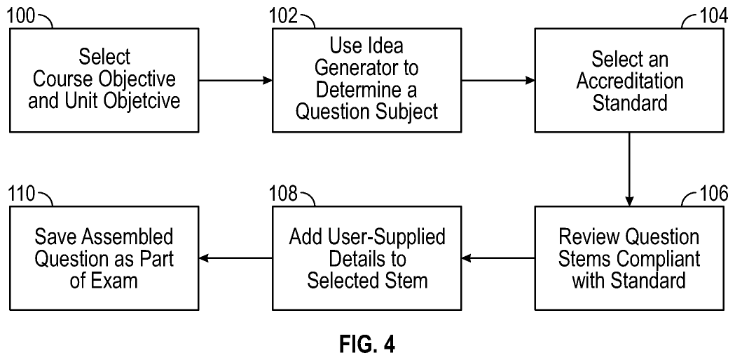

As illustrated in FIG. 4, a core question construction process begins with a user defining a framework by which question “stems” will be selected. A modifiable portion of the stem will be adapted with user-supplied content to create original test questions. User supplied content can be provided with an input device having suitable hardware and software selected from an exemplary group including a keyboard, a key pad, a mouse, a trackball, a microphone, a touch screen or the like. One skilled in the art will understand that the examples set forth herein are not limiting, and the input device can be provided in other forms, as well.

In one embodiment, there are three user inputs that govern the review stems for selection. First, the user selects from any school-mandated learning outcome and/or one of its related unit objectives 100. An example of this input is a Learning Outcome of “State outcomes of the cardiovascular system” and a Unit Objective of “Discuss diseases of the heart”.

Next there are optional idea generators which assist the user in focusing on a specific topic or subject 102. Using the previous example, an idea generator might suggest a question based on the topic of “congestive heart failure”.

The third input is the user's selection of the accreditation standard that will be targeted by a completed question 104. In the illustrated embodiment, the focus is on nursing exams, but the presently disclosed inventive concepts can be used to use questions stems from any profession with or without an accreditation standard. Once a standard is selected by the user, the user will be presented with question stems only related to that standard.

At this point in the process, the user is presented various stems, each of which can be selected, de-selected, or temporarily “held” until a final selection is made on which stem will be used as the foundation of a question 106.

Once a stem is selected, an editing interface allows the user to combine additional information of their own authorship 108 with the stem to assemble a complete question 110 that's compliant with the selected specific standard.

### Question Creation Process Overview

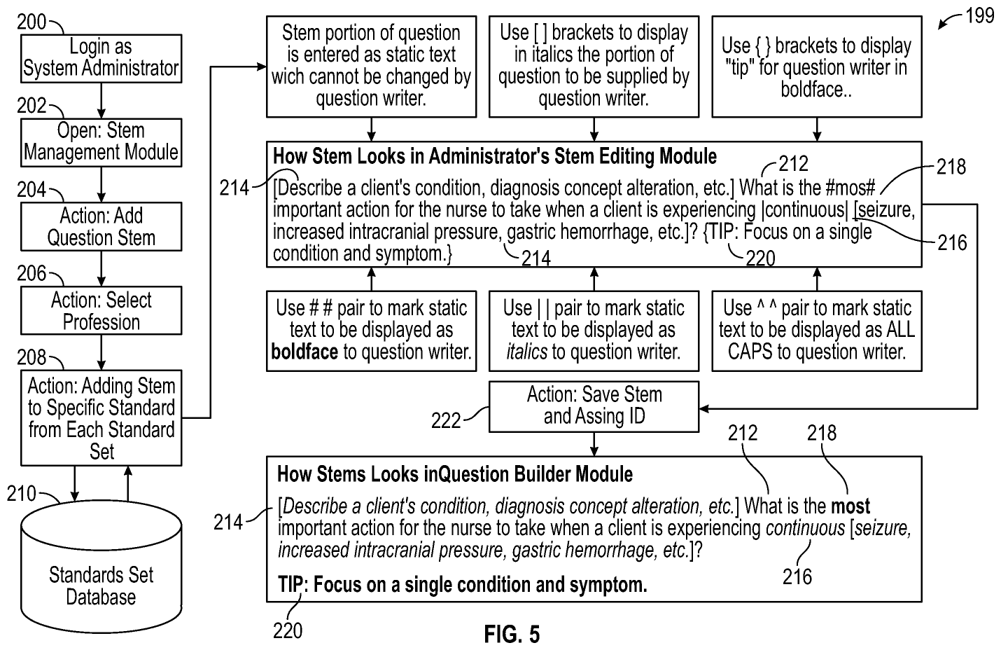

Referring now to FIG. 5, a flow diagram illustrating a method 199 of adding unique stems used to guide question writing and ensure questions are compliant with an accreditation standard.

Using the method 199, stems can be individually added or bulk imported only by a user who logs in as a System Administrator 200 who also sets or adds the specific standards to which a stem will be assigned. When the administrator opens the module for management of stems 202, the method 199 loads the interface for the addition of a new stem 204. The Administrator first chooses a profession family 206 in order to filter for and present the available standards sets associated with that profession family. In this embodiment, for example, the Administrator would choose “Nursing”. A database of standards sets 210 is then queried and a pulldown menu may be produced for each standard set applicable to the selected profession and presented to the Administrator.

In this example, a pulldown menu for each of the following professional standards sets would be produced: American Association of Critical-Care Nurses (AACN), National League of Nursing (NLN), National Council Licensure Examination (NCLEX), Quality and Safety Education for Nurses (QSEN), Nursing Process and Cognitive Level.

Each pulldown menu displays the specific standards contained in a standards set. The Administrator then selects a specific standard from each standards set for assignment to the stem 208.

For example, the pulldown menu for the Nursing Process standards set may comprise the following standards as choices:
Assessment;
Analysis;
Evaluation;
Implementation; and
Planning.

The Administrator selects one specific standard from each standards set and the stem is linked to that specific standard when the stem is saved.

Adding a single stem may be performed by use of a text editing field in application 27. Multiple stems can be bulk uploaded in a Comma Separated Value (CSV) text file, for example. Whichever method is used, in one embodiment, a stem is created or, edited only by users with administrator-level system rights. A stem consists of at least one “fixed” (uneditable) portion of text 212 and at least one “modifiable” (editable) portion of text 214. A stem can contain more than one portion of each type of text. The entire stem is stored as a unified block of text in a database 32. Special delimiters are used to mark portions of the block of text in regard to text style, placement on the screen and modifiability. This means an author of stems can embed these delimiters directly in the stem text to control the application, making it unnecessary to “hard code” styles and display placement or require use of multiple database fields (i.e. the text in the database 32 “teaches” the application 27 how to process the text being received). Specifically, when a stem is retrieved from the database 32, the embedded delimiters are parsed and identified by the application 27. Certain delimiters are discussed below merely by way of example. Delimiters other than those disclosed below can also be used. Due to the delimiters, the application then knows how to separately extract and/or display each part of the stem during the question construction process.

The fixed portion of a stem 212 is language that a user cannot later alter during the question writing process. The fixed portion of the stem is meant to be language that establishes the question as genuinely compatible with the standards assigned to the stem. Often, the fixed portion will include language establishing a baseline condition, problem, or issue that lies at the center of the question. In one embodiment, no special delimiters are placed around the fixed portion of a stem to identify the fixed portion. By default, any text in the stem's database 32 text block—not—surrounded by the special bracket (“[ ]”) delimiter is displayed by the application as simple body text which doesn't allow data entry. During the question construction process, no one can edit or delete that text, not even users with administrator-level rights.

The modifiable portion 214 of a stem is text which is meant to be replaced by the user during the question writing process. The modifiable portion 214 may provide suggestions, possible choices or ideas on how the user can customize and complete the question. In the illustrated example, the modifiable text of a stem is placed between [ ] brackets. These special delimiter bracket pairs are embedded in the stem text block during stem creation or editing by a user with administrator-level rights. When a stem's text block is retrieved from the database by the application, the delimiter pairs act as “triggers” to instruct the application 27 to separately extract and display that part of the stem. The application 27 recognizes it as text that can be edited during the question construction process. Upon selection of a stem by the user 15, this modifiable stem text is then presented in a separate field that allows data entry by the user 15.

There are other special delimiters the administrator can utilize in the static portion of the stem to control how the stem appears during the question writing process. A pair of pipe characters 216 “| |” may surround text which is to be displayed as italics. A pair of hash characters 218 “# #” may surround text which is to be displayed as boldface.

A pair of curly brackets 220 “{ }” is a special delimiter that denotes special “tip” text meant to advise or guide the question writer in some way. All tips 220 follow the main body of the stem. Tips 220 may only appear during the stem creation and question editing process. In one embodiment, tips 220 are not exported to any paper test or test export file.

When the content of the stem is ready to be finalized, the Administrator initiates the “Save” process 222, which also results in a unique serial number being assigned by the application 27 to the stem.

### Creating a New Exam

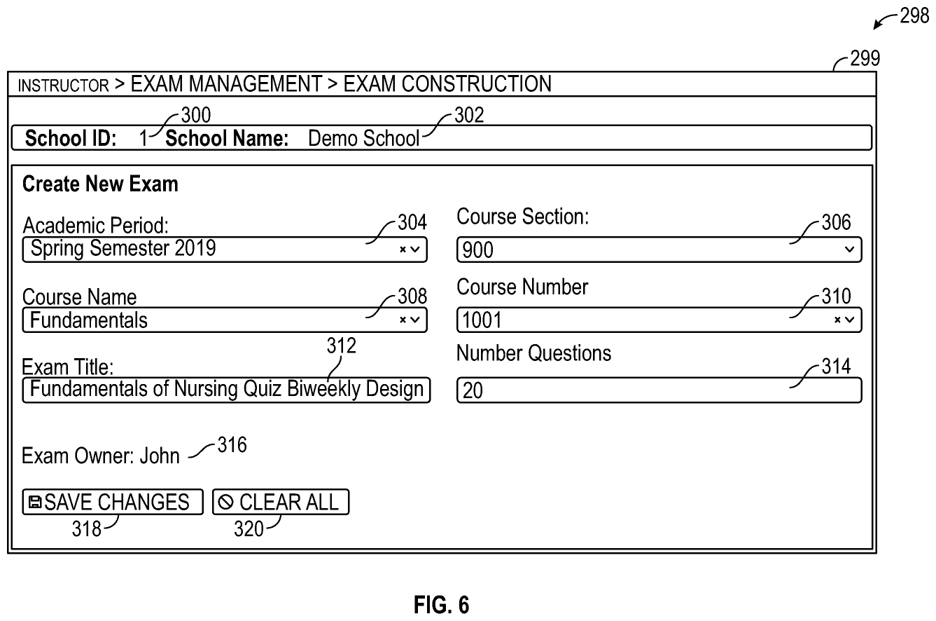

After logging in to a system 298 (which may be the user device 14, host system 12, or external system 17 described above) for creating exam questions using the input device, an instructor can access the create new exam screen 299 as illustrated in FIG. 6. Based upon the logged in user's profile, this screen first identifies the institution's identification number 300 internally assigned by the system 298, as well as the institution's name 302. The create new exam screen 299 may be provided with an academic period 304 section, course section 306 section, course name 308 section, course number 310 section which may be dropdown menus, and an exam title 312 section programmed to accept input from a user, and an exam questions 314 section programmed to accept input from the user indicative of the number of desired questions. Since all exams must be “owned” by a user, the screen shows the logged in user as the default owner 316, since he is initiating the new exam. General interface controls allow for the saving of the new exam's parameters 318 or the resetting of the entire screen 320 for the user to start over and re-enter new input.

### Managing Exams

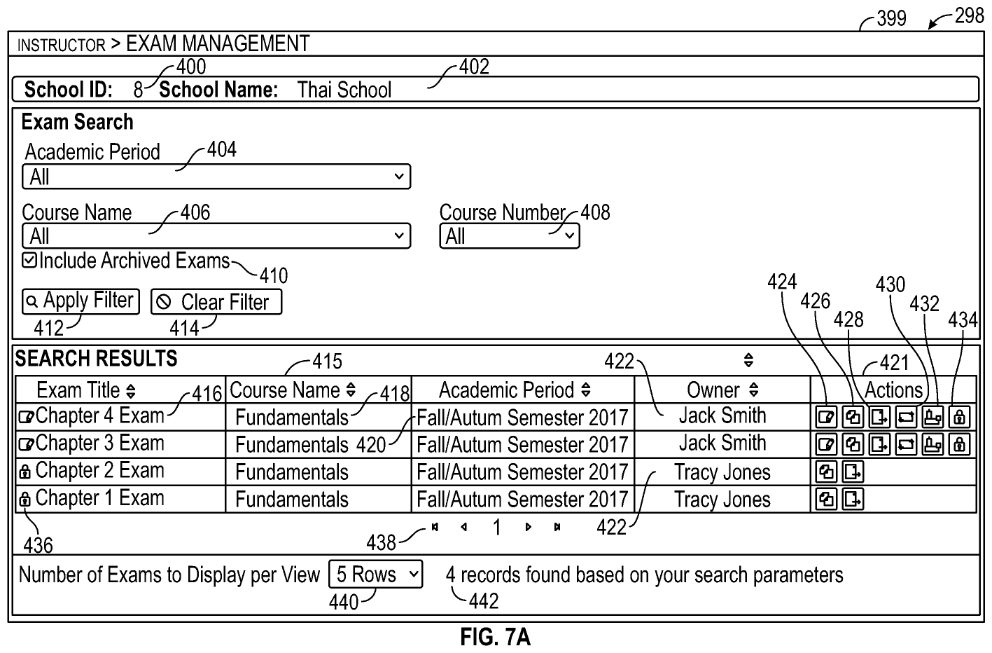

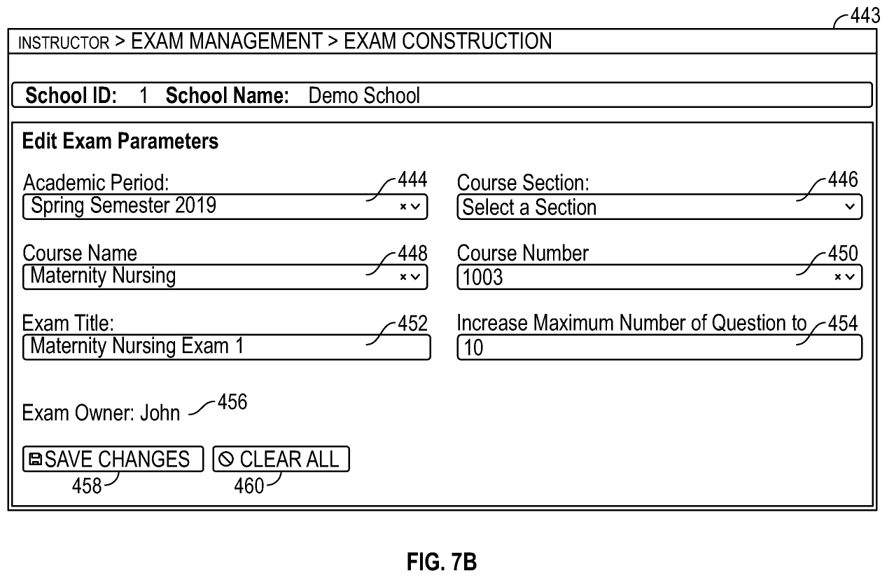

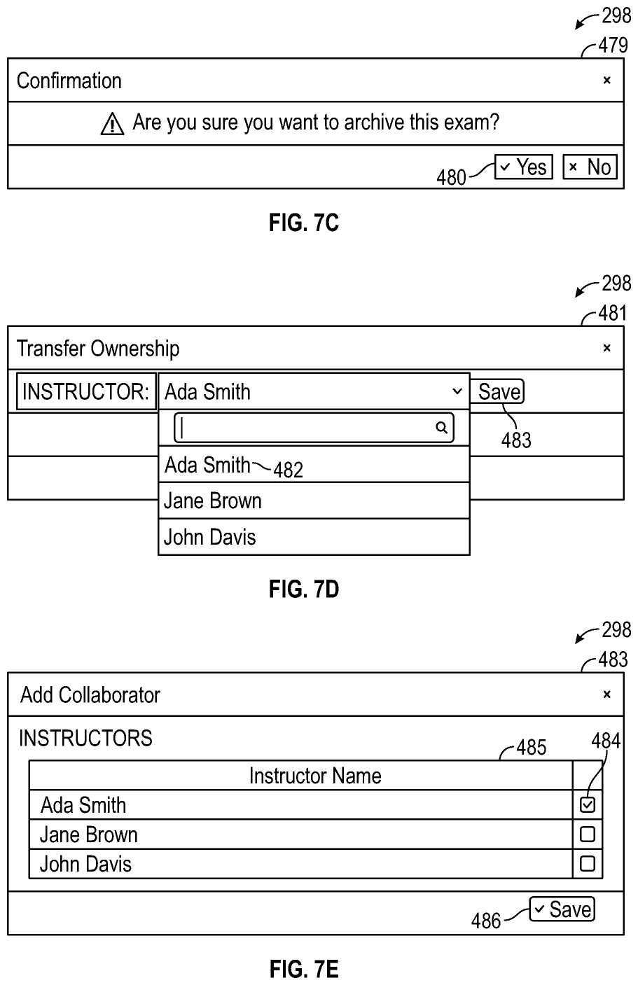

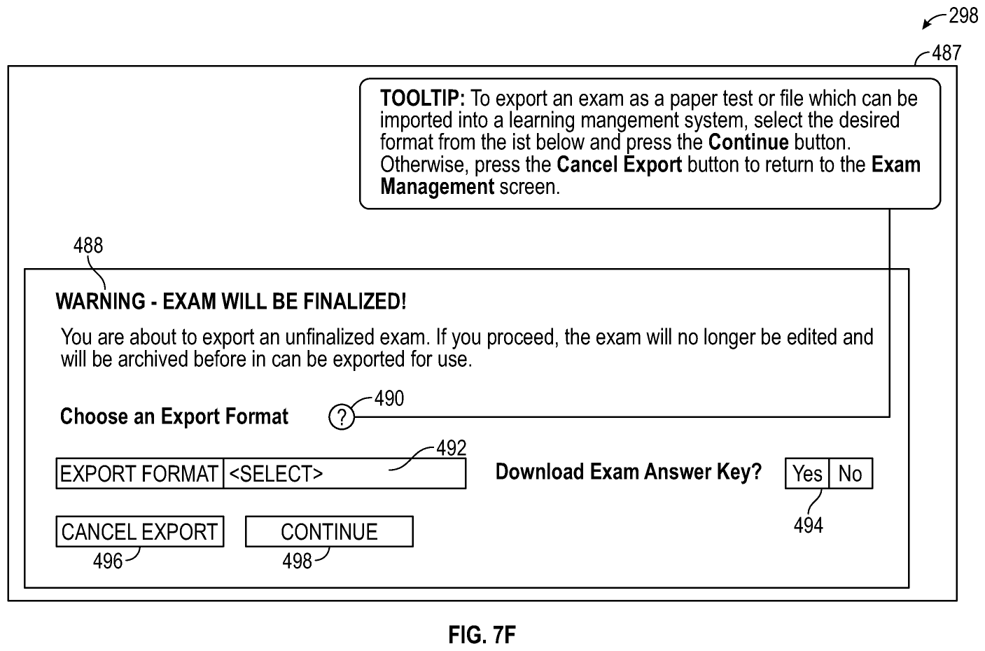

Referring now to FIG. 7a, an exam management screen 399 of the system 298 is illustrated showing a list of completed and in-progress (unfinalized) exams available to the user. Based upon the logged in user's profile, this screen first identifies the institution's identification number 400 internally assigned by the system, as well as the institution's name 402. The exam management screen 399 may default to show courses in a current term. An exam search feature is provided supporting searching using an academic period 404 section, a course name 406 section, and/or course number 408 section. A checkbox 410 allows archived (finalized) exams to be included in the search results.

Once search parameters are chosen, the user can initiate the search using the apply filter button 412 or clear all search parameters with the clear filter button 414. Search result are shown in a results table 415 which include exam title 416, course name 418, academic period and course section 420, and exam owner 422. The number of total exam records 442 found is displayed at the bottom of the screen with pagination display options 438 and 440.

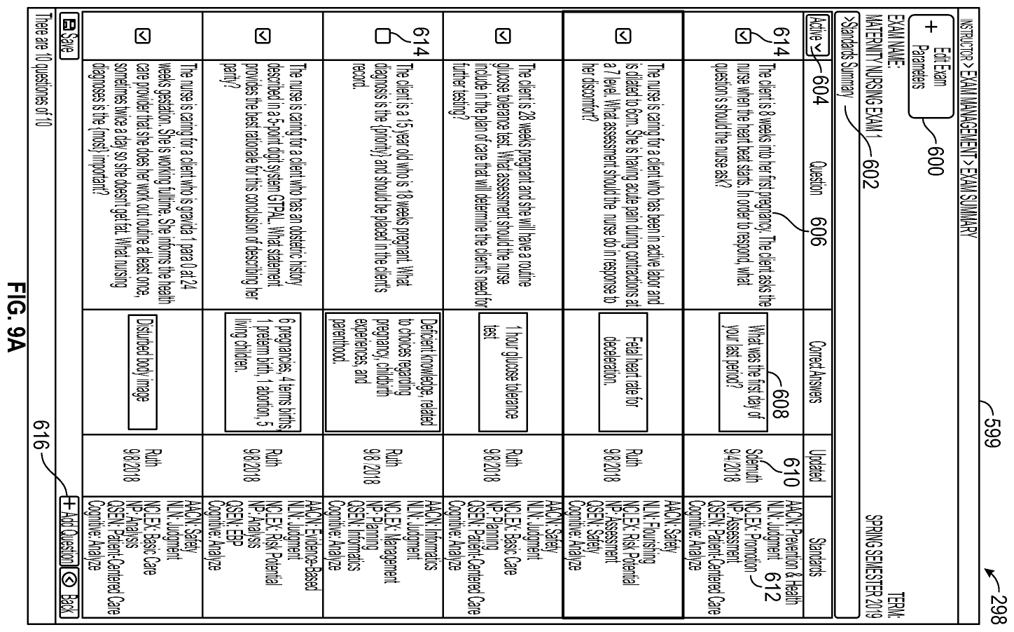

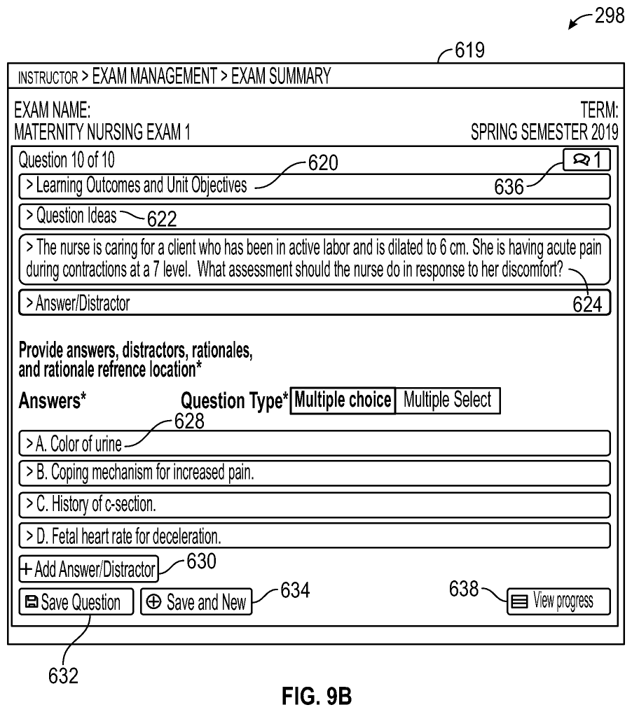

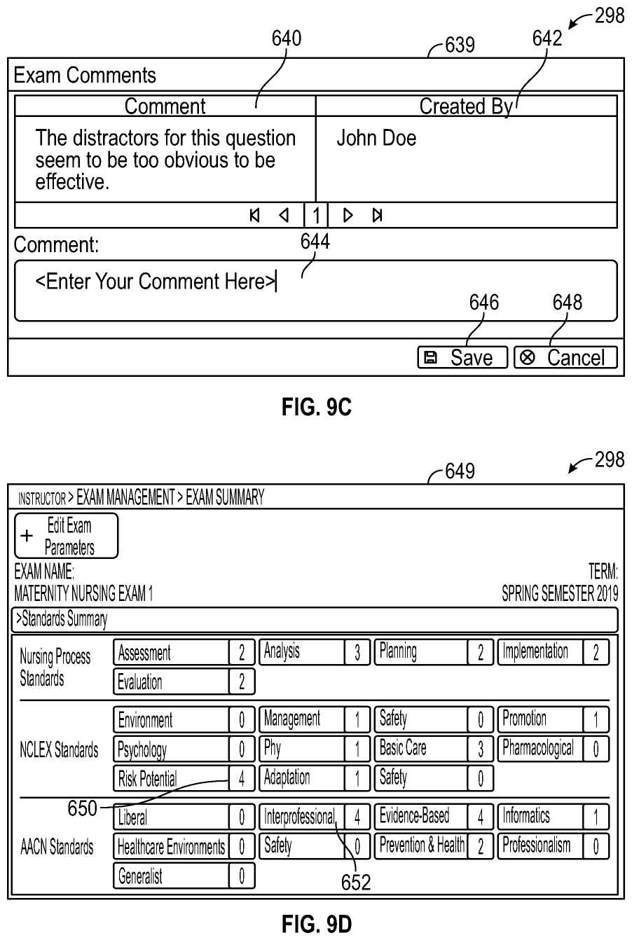

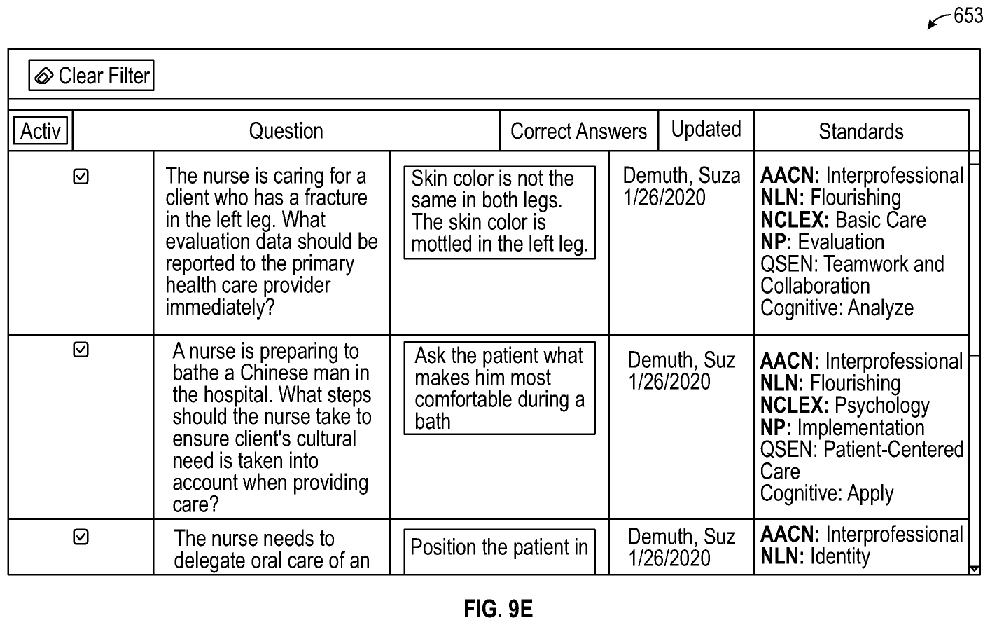

Clicking an exam title 416 opens the exam for editing as illustrated in FIG. 9A. A lock icon 436 identifies archived exams that can be reviewed or exported for test administration, but no longer altered.

The right-hand column of the results table 415 is an actions column 421 containing a row of action icons 424-434. Selecting icon 424 causes the system 298 to open an edit exam parameters screen 443 illustrated in FIG. 7b. Other action icons include copying an exam 426 to another user, exporting an exam 428 for test administration, transferring ownership of an exam 430 to another user, finalizing and archiving an exam 434, and managing the users who can comment or collaborate on the exam 432.

FIG. 7B illustrates a parameters screen 443 where an existing exam's governing parameters can be edited. To accomplish this, screen 443 is provided with an academic period selector 444, a course section selector 446, a course name selector 448, a course number selector 450, an exam title editing box 452, an increase number of questions editing box 454, exam owner section 456, a save changes button 458, and a clear all button 460. The edit exam parameters screen 443 allows the user to copy an exam for reuse in another academic period, section, or course, and course number. The new exam can be saved with a new title or shared with another instructor as a copy.

FIG. 7C illustrates a confirmation screen 479 for finalizing and archiving an exam of the system 298. Upon initiating the archival of an exam, the user may be prompted to confirm this action as archived exams can no longer be modified. To confirm archiving, the user indicates their selection in a confirmation section 480.

Course instructors can change over time. Exam ownership can be transferred to another instructor by selecting another instructor assigned to the course on a transfer screen 481 of the system 298 as illustrated in FIG. 7d. The user may select an instructor in an instructor selection section 482 and confirming that selection using a save button 483.

The course owner can select other instructors to collaborate on an exam and question development in an instructor collaboration screen 483 of the system 298, as illustrated in FIG. 7E. Other instructors assigned to teach the course will be shown in a menu 485. Selecting a checkbox 484 next to any instructor name and selecting a save button 486 will add collaborative instructors to the exam.

FIG. 7F illustrates an export exam screen 487 of the system 298. Exams may be exported in a rich text format (RTF), for instance, for printing or to be transferred to other systems that support test administration. A warning message 488 may be displayed letting the user know that exported exams are archived and will no longer be editable. For help choosing an export format, the user may select a help button 490. The user can choose an export format to download from a list of supported types using menu 492. The export types primarily include specially constructed files that can be downloaded then re-imported into test analysis or learning management systems of other vendors for the purposes of test administration. An answer key for the exam can also be requested using selector 494. The user may continue to initiate the download by selecting a continue button 498 or cancel if desired by selecting a cancel button 496.

### The Question Builder

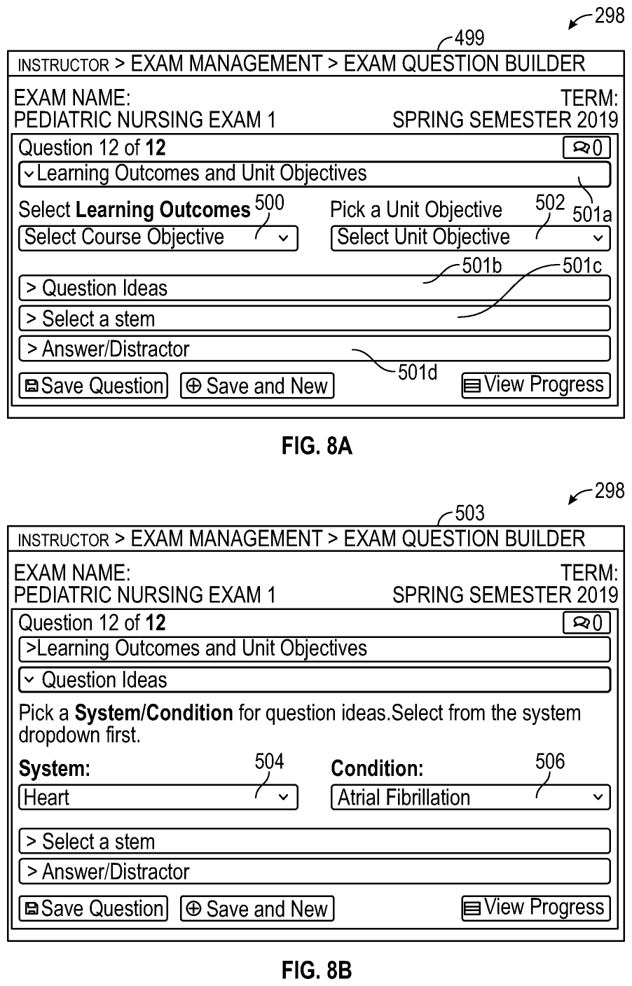

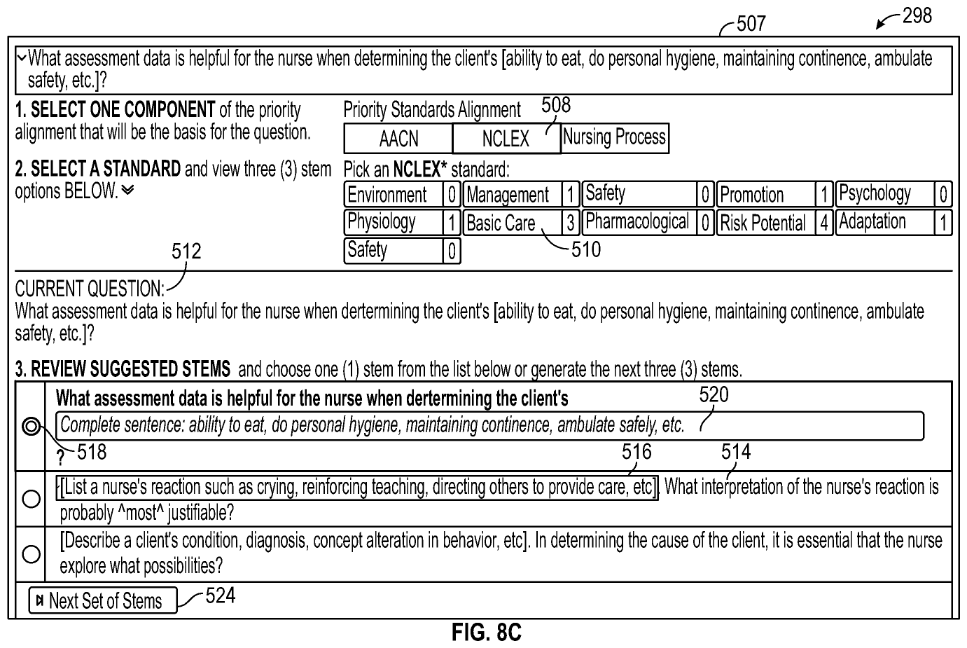

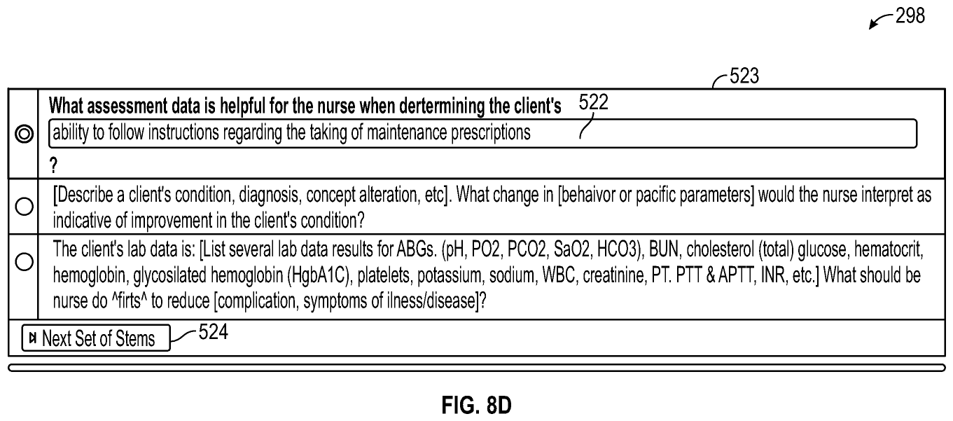

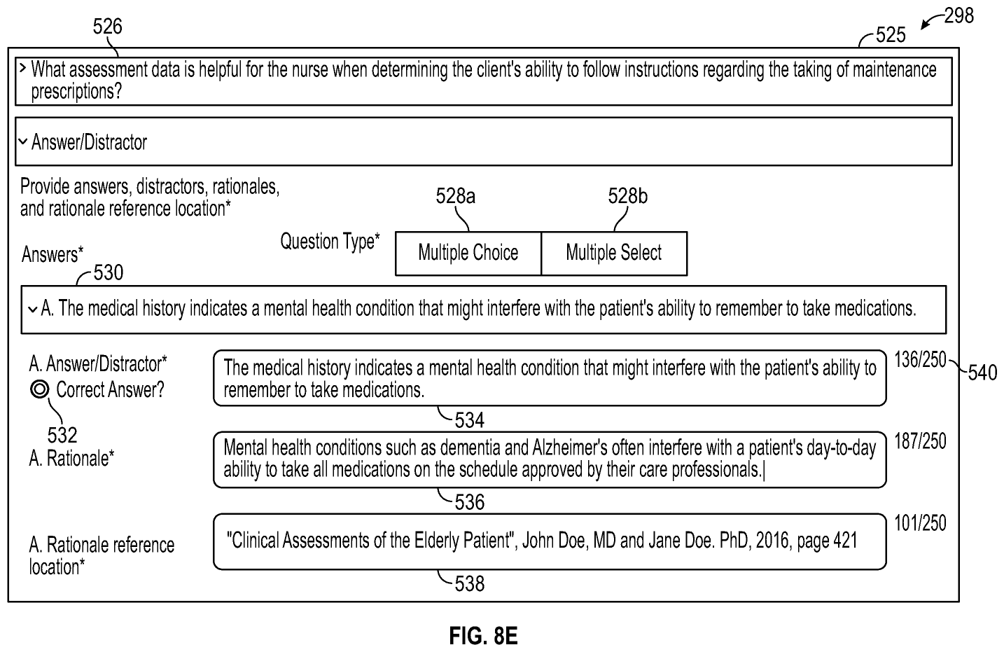

As illustrated in FIG. 8A, a link screen 499 of the system 298 is provided with four expandable sections, a learning outcomes and unit objectives 501a section, a question ideas 501b section, a stem selection 501c section, and an answers/distractors 501d section.

During the question building process illustrated in FIG. 8A, the first step in forming each question is to choose a Learning Outcome and Unit Objective. The Learning Outcome and Unit Objective may be chosen using dropdown menus 500 and 502, respectively, for example. The Learning Outcome 500 and Unit Objective 502 are based on what the user's school determines must be accomplished in the course to comply with accreditation requirements. Learning Outcomes 500 are broad categories/goals of what the student is expected to learn about certain subject matter, and Unit Objectives 502 are specific types of information within the subject matter. For example, a Learning Outcome 500 might be “the student will examine how the health of the circulatory system fits into overall wellness.” A Unit Objective 502 might then be “Discuss methods of recognizing heart attack symptoms” or “Describe the types of artery diseases”.

Though the Learning Outcome 500 and Unit Objective 502 for a course is determined as shown in FIG. 8A, the user may be offered optional help from the system 298 by generating specific topics that guide stem selection and formulation of a complete question. There are two types of idea generators for different educational approaches contained in the current application 27: System/Condition and Themes/Concepts. Each school designates which educational approach will be used by its users. For this embodiment, FIG. 8B illustrates a medically oriented idea generator of bodily systems and diseases on a generating question ideas screen 503 of system 298. A System 504 section is chosen first, thereby filtering and limiting the list presented in Condition 506 section to those conditions compatible with the system chosen using System 504 section.

FIG. 8C illustrates the interaction between the library of question stems and the accreditation standards those stems support. To obtain the correct stems from which to build questions, the system 298 is provided with a question stems screen 507. The question stems screen 507 is provided with a Standards Alignment categories 508 section that allows the user to select a standards alignment category. For instance, FIG. 8C illustrates an NCLEX category selected. Once the category is chosen, specific topical areas of the NCLEX standard are displayed for the user to select in a topical area section 510. In FIG. 8C, eleven topical areas are displayed in the topical area section 510 such as “Safety”, “Basic Care”, etc. The boxes to the right of each topical area name shows the corresponding number of existing questions for that standard category in the current exam. For example, in FIG. 8C there is currently one question in the exam aligned to the “Physiology” standard and three questions in the exam aligned to the “Basic Care” standard. It should be noted that these exemplary categories are provided for the purposes of illustration only and are not limiting. The currently disclosed inventive concepts are designed to accommodate different Alignments Standards and topical areas, making it useful for a wide array of professions, accreditation standards, and testing situations.

Once the user selects one of the topical areas 510, the question stem library is searched for stems that are compatible with both the Standards Alignment and topical area. Three of the stems found in the search are then randomly selected and presented to the user for review.

“Raw” question stems consist of two parts: a fixed, unmodifiable portion 514 and a user-modifiable portion 516. The user-modifiable portion 516 is initially presented to the user as text between “[ ]” brackets, so the information needed from the user to add to the stem to construct a complete question can readily be determined.

If the user wants to use one of the stems, the user can select it using a radio button 518 and the stem will be re-displayed in split form 520, presenting the user a form field in which to type user-modifiable text that can be inserted into the question stem. At all times, the text of the user-supplied data combined with the question stem are shown as a complete, merged question 512 for constant review and clarity.

The user can request that the system 298 display alternate stems for review by clicking on a next set of stems button 524. Alternate stems are displayed on an alternate stem screen 523 shown in FIG. 8D. If a stem has already been selected by clicking on it at the time of such a request, it will be held in the list and displayed in its last edited state 522. Two more question stems will be loaded beneath it for review. If no stem is previously selected for editing, three question stems will be randomly chosen and displayed.

Once a question is assembled from user-supplied data and a vetted question stem, correct and incorrect answers need to be attached to the question. FIG. 8E illustrates the provision of a correct answer using an answers screen 525 of the system 298. First, the final version of the assembled question is shown at the top of a user's interface 526 of the answers screen 525. In the illustrated embodiment, two answer formats are allowed Multiple Choice 528a or Multiple Select 528b, where more than one answer is correct. In either format, the latest edited version of the answer is shown to the user in correct answer section 530. The correct answer to a question is marked by clicking a radio button 532. The actual text of an answer is entered in a required field 534. For the exam question to later be reviewed by accreditation personnel and others, additional information pertaining to the correct answer is required. Rationale 536 is an explanation of why the answer is correct and Reference 538 is a citation for a reference source from which the Rationale 534 was obtained.

User supplied distractors (incorrect answers) for an assembled question are provided for using the same interface as correct answers, except that the radio button 532 designating a correct answer is NOT selected.

Best practices dictate answers and distractors be of similar length. Character counts and limits are shown to the user in section 540. School administrators can set an upper character limit to ensure consistency.

### Exam Summary

FIG. 9A illustrates an exam summary screen 599 of system 298 which centralizes all information about a specific exam so the stem-based questions can constantly be reviewed for adherence to accreditation standards.

A quick-action button 600 is provided which allows the user to edit/change the parameters for the currently open exam. Refer to FIG. 7B for examples of the parameters that can be edited.

An expandable standards summary section 602 can be opened that will provide a detailed, consolidated, statistical summary of how the exam's questions are distributed across all the standards selected for use by the school. The standards summary is presented in more detail in FIG. 9D.

Individual questions can be marked as either “active” or “inactive” by use of a checkbox 614. Questions which are marked “inactive” will not be included in the final version of the exam when it's archived and/or exported for use. A filtering menu 604 allows the user to view only “active” or “inactive” questions in the question listing.

Clicking on an individual question 606 results in a question-editing interface opening as illustrated in FIG. 9B. The correct answer for each question in the list is displayed in section 608, as well as the date of the last change made to the question and the username of who made the change in section 610.

Though each stem-based question is compliant with the user's selection of a specific targeted standard, it must be remembered that in this example, stems are compliant with multiple standards. As an example, a stem can simultaneously be compliant with the Assessment standard in the Nursing Process standards group and the Judgment standard in the NLN standards group. For that reason, it's useful to show both the targeted and non-targeted standards with which the question is compatible, and this is done in the Standards column of the listing 612.

An Add Question 616 button at the bottom of the exam summary screen 599 will initiate the same stem-based question construction process as illustrated and described in reference to FIGS. 8A, 8B, 8C, 8D, and 8E.

### Editing Existing Exam Question

Referring now to FIG. 9B, a question editing screen 619 is illustrated. In some embodiments, the question editing screen 619 only allows the user to edit a question previously added to an exam. The editing process uses many of the same processes as those used to add a new question to an exam. Clicking anywhere in a Learning Outcomes and Unit Objectives section 620 loads an interface like that shown in FIG. 8A. Additional ideas for changing the subject of a question can be generated by clicking in a Question Ideas section 622 that loads an interface like that shown in FIG. 8B.

In one embodiment, clicking anywhere in a question section 624 will open an interface that allows the user to either (a) combine new user-supplied information with the selected question stem, or (b) select a completely different question stem for use in formulating a replacement question. This functionality will work similarly to that shown in FIGS. 8C and 8D, except that all previous answers and distractors are pre-loaded for review and possible editing.

In one embodiment, each individual answer or distractor can be opened and edited by clicking on the answer or distractor as shown in section 628. In one embodiment, the answer/distractor editing functionality works the same as shown in FIG. 8E. While in the mode for editing a question, additional answers or distractors can be added to the question by use of an Add Answer/Distractor button 630. If edits to a question are implemented, the edits can be saved by using a Save Question button 632 or a Save and New button 634 can be used that will save changes made to the current question and open the same interface as shown in FIG. 8A for a new question to be constructed.

In some embodiments, more than one user can take part in developing the same exam. This is because the application 27 tracks relationships between users, courses, exams, and exam questions by utilizing unique IDs for each of those objects in the database 32. Users can only create exams for courses to which they are assigned. The user who originally creates an exam is considered the exam's “owner”. Other users can subsequently be assigned to the exam by the exam owner. These additional users must also be assigned to the same course to which the exam is linked and are considered to be “collaborators”. Collaborators are assigned as one of two types: “Contributors” and “Commentators”. Contributor collaborators are allowed to create, edit and delete exam questions. Commentator collaborators are limited to leaving comments and suggestions attached to individual questions. These comments and suggestions don't appear on the exams but only as part of the question construction and editing process. To leave or review comments, a comments icon 636 in the upper right-hand corner of the interface (as shown in FIG. 9B.) is selected and loads a dialogue box as shown in FIG. 9C.

The user can return to an overall review of the exam by clicking on a View Progress button 638, which will present the entire current version of the exam as shown in FIG. 9A.

During the question construction process, every user assigned to an exam can offer commentary and suggestions on any question in the exam. FIG. 9C illustrates a dialog box 639 of system 298 where reading and entering comments is performed. Comments left by users other than the logged-in user are first displayed in the dialog box 639, with the comment on the left in section 640 and the username of the user who left it displayed in the right in section 642. The logged in user can use a comment box 644 to enter the user's own comment. Selecting the Save button 646 will save the comment for future presentation to all associated users. Selecting the Cancel button 648 will vacate the dialog box without saving any comment and return the user to the question construction interface 619.

Referring now to FIG. 9D, an exam blueprint summary screen 649 of system 298 is provided to enable user review of the standards that are covered in an exam. This summary is a census of exactly which standards are linked to the question stems used in the completed questions. In FIG. 9D, the distribution of 11 exam questions is shown for each of the three standards available for use by the school. This summary allows users to determine if the exam is weighted too heavily toward certain standards. For example, the user may determine that 4 questions, as indicated by number section 650, pertaining to the Risk Potential standard is too many and may want to edit one of those 4 questions to be linked to another standard. To easily identify which questions should be targeted for editing, the application allows the user to click on any individual standard to filter the list of questions viewed in the Exam Summary FIG. 9A. For example, in FIG. 9D, selecting AACN Interprofessional standard as shown in section 652 would limit the questions displayed in the Exam Summary to the 4 questions linked to that specific standard. The user could then pick one of those questions for editing and reassignment to another standard. It should be noted that while only one number section 650 and one standard section 652 are indicated in FIG. 9D, each of the other number sections and standard sections operate in a similar fashion.

FIG. 9E illustrates a list of questions 653 which have been filtered based on the selection of the AACN Interprofessional standard shown by section 652 in FIG. 9D.

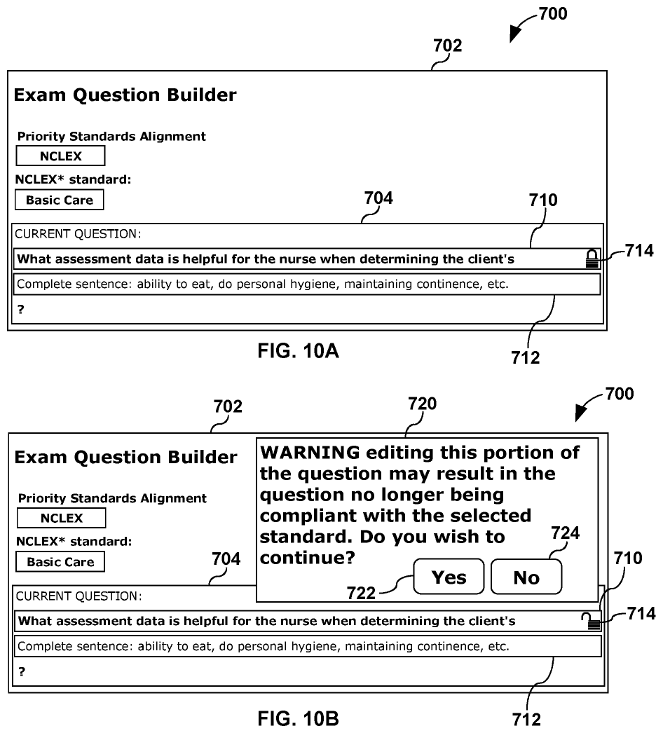

Referring now to FIGS. 10A-10B, another embodiment of a system 700 is illustrated. The system 700 operates in similar fashion to the system 298 described above. Therefore, only the differences between the system 700 and the system 298 will be described in detail herein. The system 700 is provided with an exam question builder screen 702 for editing exam question stems 704 suggested or provided by the system 700.

The exam question stem 704 is provided with a locked portion 710 and an unlocked portion 712. As with the modifiable portion 214 described above, the user may edit the unlocked portion 712 to create a new exam question that is compliant with a selected standard (NCLEX, for example, is illustrated in FIGS. 10A and 10B) when the locked portion 710 is unchanged.

In the system 700, the locked portion 710 is in a non-editable state unless the user takes an unlocking action to unlock the locked portion 710. The unlocking action may be one or more affirmative step or series of steps or computer input undertaken by a user to make a selection indicating the user's desire to unlock the lock portion 710. For instance, the locked portion 710 may be programmed to become editable when the user selects the locked portion 710, when the user double clicks some part of the locked portion 710, when the user selects an unlock button 714, or similar action. In other words, the system 700 is programmed to keep the locked portion 710 in the non-editable state unless the user performs some action indicating that the user wishes to edit the locked portion 710.

The system 700 allows the user to edit the locked portion 710 but provides a warning indicator, e.g., some form of caution or warning, to let the user know that editing the locked portion 710 may result in the new question no longer being compliant with the selected standard. For instance, the system 700 may be provided with warning indicator 720 that pops up or appears visually when the user attempts to edit the locked portion 710 to ensure that the user understands that editing the locked portion 710 may result in the new question created by editing the locked portion 710 no longer being compliant with the selected standard. The warning indicator 720 may require secondary confirmation from the user to ensure that the user has read and understands the message contained in the warning indicator 720 and still wants to continue to edit the locked portion 710 such as a selectable indicator, e.g., a yes button 722. When the user selects the yes button 722, the system 700 is programmed to take the user back to the exam question builder screen 702 where the locked portion 710 will then be in an editable state and will accept input from the user.

If the user decides not to edit the locked portion 710 in response to receiving the warning 720, the user may select a no button 724. In response to selection of the no button 724, the system 700 is programmed to cause the warning 720 to disappear and take the user back to the exam question builder screen 702 where the locked portion 710 will remain in the non-editable state.

While the system 700 is illustrated having the warning indicator 720, other embodiments of the system 700 may be provided with different methods of cautioning the user that editing the locked portion 710 may result in a new question not being compliant with a selected standard. For instance, the exam question builder screen 702 may be provided with a locked portion (not shown) and an unlocked portion (not shown) where text in the locked portion is visually differentiated from text in the unlocked portion. For instance, the text in the locked portion may be in a bold font, italics font, a different color, a different font, a different font size, or any combination of these so the user can differentiate between text in the locked portion and text in the unlocked portion. The exam question builder screen 702 may be provided with warning text (not shown) cautioning the user that editing the visually differentiated text of the locked portion may result in a new question no longer being compliant with the selected standard.

The system 700 may be further programmed to generate a report when the user edits the locked portion 710. For instance, when the user creates an exam having multiple questions, the report may list all of the questions and indicate questions where the user edited the locked portion 710. The report may be used to further remind the user that the questions where the locked portion 710 have been edited may no longer be compliant with the selected standard. Further, the report may be used by administrators so that exams where the locked portion 710 was changed are reviewed to ensure they are compliant with the selected standard.

In some embodiments, the system 700 may require that the user be an authorized user, such as an administrator of the system 700, before allowing the user to access and/or edit the locked portion 710. In another embodiment, the system 700 may be further programmed to require approval of new exam questions where the locked portion 710 has been edited from an administrative body, such as school administration, before an exam containing the new exam questions may be administered.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

What is claimed is:

1. An exam building system, comprising:
a display device, an input device, one or more processor, and non-transitory computer readable medium storing computer executable instructions that when executed by the one or more processor cause the one or more processor to;
access, from a database stored on the non-transitory computer readable medium, an exam question stem, the exam question stem having a modifiable portion and an unmodifiable portion;
display the exam question stem on the display device;
accept input from a user, using the input device, the input changing the modifiable portion of the exam question stem to create a new exam question that, because of the unmodifiable portion of the exam question stem, is compliant with a standard; and
save the new exam question on the non-transitory computer readable medium associated with an exam.

2. The exam building system of claim 1, wherein the computer executable instructions cause the one or more processors to create an unmodifiable archive of the exam before the exam is exported for exam administration.

3. The exam building system of claim 1, wherein the exam is a second exam and the exam question stem is a copy of an existing exam question compliant with a standard from a first exam, the modifiable portion changeable to create a new question that, because of the unmodifiable portion of the exam question stem remains compliant with the standard.

4. The exam building system of claim 1, wherein the computer executable instructions when executed by the one or more processor further cause the one or more processor to accept input from the user indicating a desired topic and uses the input of the desired topic to access exam question stems related to the desired topic from the database stored on the non-transitory computer readable medium.

5. The exam building system of claim 1, wherein the new exam question is a multiple choice question and the exam building system is further programmed to accept input from the user indicative of a correct answer and one or more distractors, the input for each of the correct answer and the one or more distractors having a character limit.

6. The exam building system of claim 1, wherein the standard is predetermined and the computer executable instructions are configured to only access exam question stems that are compliant with the predetermined standard.

7. The exam building system of claim 1, wherein the computer executable instructions are configured to accept input from the user indicative of a desired standard and to only access exam question stems that are compliant with the desired standard input by the user.

8. The exam building system of claim 1, wherein the user is a first user and the computer executable instructions are programmed to accept input from the first user indicative of a selection of a second user as a collaborator on the exam.

9. A method of building an exam, comprising:
accessing, from a database stored on a non-transitory computer readable medium, an exam question stem, the exam question stem having a modifiable portion and an unmodifiable portion;
displaying the exam question stem on a display device;
accepting input from a user, using an input device, the input changing the modifiable portion of the exam question stem to create a new exam question that, because of the unmodifiable portion of the exam question stem, is compliant with a standard; and
saving the new exam question on the non-transitory computer readable medium associated with an exam.

10. The method of building an exam of claim 9, wherein an unmodifiable archive of the exam is saved to the non-transitory computer readable medium before the exam is exported for exam administration.

11. The method of building an exam of claim 9, wherein the exam is a second exam and the exam question stem is a copy of an existing exam question compliant with a standard from a first exam, the modifiable portion changeable to create a new question that, because of the unmodifiable portion of the exam question stem remains compliant with the standard.

12. The method of building an exam of claim 9, wherein the method further comprises:
accepting input from the user indicating a desired topic; and
accessing exam question stems related to the desired topic from the database stored on the non-transitory computer readable medium.

13. The method of building an exam of claim 9, wherein the new exam question is a multiple choice question and the method further comprises accepting input from the user indicative of a correct answer and one or more distractors, the input for each of the correct answer and the one or more distractors having a character limit.

14. The method of building an exam of claim 9, wherein the standard is predetermined and only exam question stems that are compliant with the predetermined standard are accessible.

15. The method of building an exam of claim 9, wherein the method further comprises accepting input from the user indicative of a desired standard and only exam question stems that are compliant with the desired standard input by the user are accessible.

16. The method of building an exam of claim 9, wherein the user is a first user and the method further comprises accepting input from the first user indicative of a selection of a second user as a collaborator on the exam.

17. An exam building system, comprising:
a display device, an input device, one or more processor, and non-transitory computer readable medium storing computer executable instructions that when executed by the one or more processor cause the one or more processor to;
access, from a database stored on the non-transitory computer readable medium, an exam question stem, the exam question stem having a locked portion and an unlocked portion;
display the exam question stem on the display device;
accept input from a user, using the input device, the input changing the unlocked portion of the exam question stem to create a new exam question that is compliant with a selected standard;
accept input from the user, using the input device, the input indicating selection of the locked portion; and
in response to receiving the input indicating selection of the locked portion displaying a warning indicator that changing the locked portion may result in the new exam question not being compliant with the selected standard.

18. The exam building system of claim 17, wherein, after displaying the warning indicator, the computer executable instructions cause the system to accept input from the user changing the locked portion of the exam question stem to create a new exam question and generate a report indicating that the locked portion has been changed.

19. The exam building system of claim 17, wherein the computer executable instructions are configured to accept input from the user indicative of a desired standard and to only access exam question stems that are compliant with the desired standard input by the user.

20. The exam building system of claim 17, wherein the user is a first user and the computer executable instructions are programmed to accept input from the first user indicative of a selection of a second user as a collaborator on the new exam question.
